(19) United States
(12) Patent Application Publication
(10) Pub. No.: US 2018/0176937 A1
(43) Pub. Date: Jun. 21, 2018

(54) METHOD AND APPARATUS OF HANDLING MULTIPLE UPLINK RESOURCE COLLISIONS IN A WIRELESS COMMUNICATION SYSTEM

(71) Applicant: ASUSTek Computer Inc., Taipei City (TW)

(72) Inventors: Wei-Yu Chen, Taipei City (TW); Hsin-Hsi Tsai, Taipei City (TW); Li-Chih Tseng, Taipei City (TW)

(21) Appl. No.: 15/843,997

(22) Filed: Dec. 15, 2017

Related U.S. Application Data
(60) Provisional application No. 62/435,344, filed on Dec. 16, 2016.

(51) Int. Cl. H04W 72/12; H04W 72/04; H04W 74/08; H04W 72/06

(52) U.S. Cl. CPC H04W 72/1257; H04W 72/0413; H04W 72/1268; H04W 72/06; H04W 74/085

(57) ABSTRACT

A method and apparatus are disclosed from the perspective of a UE (User Equipment). In one embodiment, the method includes having at least a first uplink resource and a second uplink resource, wherein the first uplink resource and the second uplink resource collides in a time domain. The method further includes prioritizing the first uplink resource according to a first method. The method also includes performing an uplink transmission on the first uplink resource.

### CROSS-REFERENCE TO RELATED APPLICATIONS

The present Application claims the benefit of U.S. Provisional Patent Application Ser. No. 62/435,344 filed on Dec. 16, 2016, the entire disclosure of which is incorporated herein in its entirety by reference.

### FIELD

This disclosure generally relates to wireless communication networks, and more particularly, to a method and apparatus of handling multiple uplink resource collisions in a wireless communication system.

### BACKGROUND

With the rapid rise in demand for communication of large amounts of data to and from mobile communication devices, traditional mobile voice communication networks are evolving into networks that communicate with Internet Protocol (IP) data packets. Such IP data packet communication can provide users of mobile communication devices with voice over IP, multimedia, multicast and on-demand communication services.

An exemplary network structure is an Evolved Universal Terrestrial Radio Access Network (E-UTRAN). The E-UTRAN system can provide high data throughput in order to realize the above-noted voice over IP and multimedia services. A new radio technology for the next generation (e.g., 5G) is currently being discussed by the 3GPP standards organization. Accordingly, changes to the current body of 3GPP standard are currently being submitted and considered to evolve and finalize the 3GPP standard.

### SUMMARY

A method and apparatus are disclosed from the perspective of a UE (User Equipment). In one embodiment, the method includes having at least a first uplink resource and a second uplink resource, wherein the first uplink resource and the second uplink resource collides in a time domain. The method further includes prioritizing the first uplink resource according to a first method. The method also includes performing an uplink transmission on the first uplink resource.

### BRIEF DESCRIPTION OF THE DRAWINGS

FIG. 1 shows a diagram of a wireless communication system according to one exemplary embodiment.

FIG. 2 is a block diagram of a transmitter system (also known as access network) and a receiver system (also known as user equipment or UE) according to one exemplary embodiment.

FIG. 3 is a functional block diagram of a communication system according to one exemplary embodiment.

FIG. 4 is a functional block diagram of the program code of FIG. 3 according to one exemplary embodiment.

FIG. 5 is a reproduction of Figure 6.1.3.1-1 of 3GPP TS 36.321 V14.0.0.

FIG. 6 is a reproduction of Figure 6.1.3.1-2 of 3GPP TS 36.321 V14.0.0.

FIG. 7 is a reproduction of Table 6.1.3.1-1 of 3GPP TS 36.321 V14.0.0.

FIG. 8 is a reproduction of Table 6.1.3.1-2 of 3GPP TS 36.321 V14.0.0.

FIG. 9 is a timing diagram according to one exemplary embodiment.

FIG. 10 is a timing diagram according to one exemplary embodiment.

FIG. 11 is a flow chart according to one exemplary embodiment.

FIG. 12 is a flow chart according to one exemplary embodiment.

FIG. 13 is a flow chart according to one exemplary embodiment.

### DETAILED DESCRIPTION

The exemplary wireless communication systems and devices described below employ a wireless communication system, supporting a broadcast service. Wireless communication systems are widely deployed to provide various types of communication such as voice, data, and so on. These systems may be based on code division multiple access (CDMA), time division multiple access (TDMA), orthogonal frequency division multiple access (OFDMA), 3GPP LTE (Long Term Evolution) wireless access, 3GPP LTE-A or LTE-Advanced (Long Term Evolution Advanced), 3GPP2 UMB (Ultra Mobile Broadband), WiMax, or some other modulation techniques.

In particular, the exemplary wireless communication systems devices described below may be designed to support one or more standards such as the standard offered by a consortium named “3rd Generation Partnership Project” referred to herein as 3GPP, including: TR 38.913 V0.3.0, “Study on Scenarios and Requirements for Next Generation Access Technologies”; and TS 36.321 V14.0.0, “Medium Access Control (MAC) protocol specification”. The standards and documents listed above are hereby expressly incorporated by reference in their entirety.

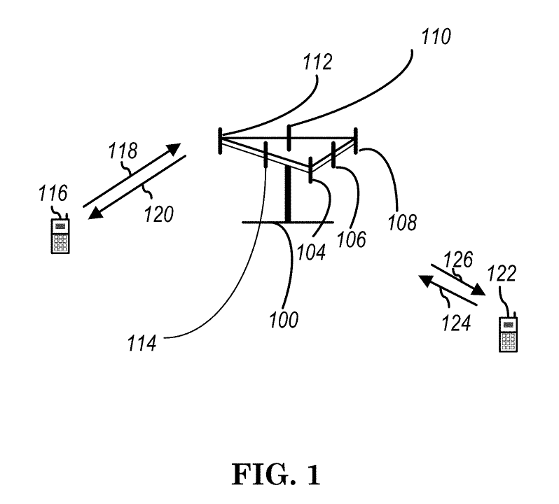

FIG. 1 shows a multiple access wireless communication system according to one embodiment of the invention. An access network 100 (AN) includes multiple antenna groups, one including 104 and 106, another including 108 and 110, and an additional including 112 and 114. In FIG. 1, only two antennas are shown for each antenna group, however, more or fewer antennas may be utilized for each antenna group. Access terminal 116 (AT) is in communication with antennas 112 and 114, where antennas 112 and 114 transmit information to access terminal 116 over forward link 120 and receive information from access terminal 116 over reverse link 118. Access terminal (AT) 122 is in communication with antennas 106 and 108, where antennas 106 and 108 transmit information to access terminal (AT) 122 over forward link 126 and receive information from access terminal (AT) 122 over reverse link 124. In a FDD system, communication links 118, 120, 124 and 126 may use different frequency for communication. For example, forward link 120 may use a different frequency then that used by reverse link 118.

Each group of antennas and/or the area in which they are designed to communicate is often referred to as a sector of the access network. In the embodiment, antenna groups each are designed to communicate to access terminals in a sector of the areas covered by access network 100.

In communication over forward links 120 and 126, the transmitting antennas of access network 100 may utilize beamforming in order to improve the signal-to-noise ratio of forward links for the different access terminals 116 and 122. Also, an access network using beamforming to transmit to access terminals scattered randomly through its coverage causes less interference to access terminals in neighboring cells than an access network transmitting through a single antenna to all its access terminals.

An access network (AN) may be a fixed station or base station used for communicating with the terminals and may also be referred to as an access point, a Node B, a base station, an enhanced base station, an evolved Node B (eNB), or some other terminology. An access terminal (AT) may also be called user equipment (UE), a wireless communication device, terminal, access terminal or some other terminology.

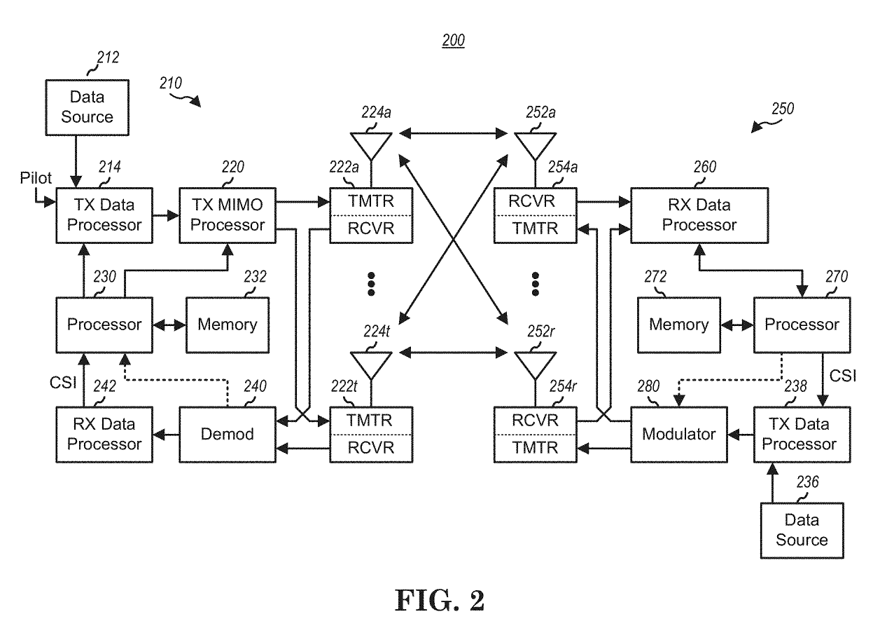

FIG. 2 is a simplified block diagram of an embodiment of a transmitter system 210 (also known as the access network) and a receiver system 250 (also known as access terminal (AT) or user equipment (UE)) in a MIMO system 200. At the transmitter system 210, traffic data for a number of data streams is provided from a data source 212 to a transmit (TX) data processor 214.

In one embodiment, each data stream is transmitted over a respective transmit antenna. TX data processor 214 formats, codes, and interleaves the traffic data for each data stream based on a particular coding scheme selected for that data stream to provide coded data.

The coded data for each data stream may be multiplexed with pilot data using OFDM techniques. The pilot data is typically a known data pattern that is processed in a known manner and may be used at the receiver system to estimate the channel response. The multiplexed pilot and coded data for each data stream is then modulated (i.e., symbol mapped) based on a particular modulation scheme (e.g., BPSK, QPSK, M-PSK, or M-QAM) selected for that data stream to provide modulation symbols. The data rate, coding, and modulation for each data stream may be determined by instructions performed by processor 230.

The modulation symbols for all data streams are then provided to a TX MIMO processor 220, which may further process the modulation symbols (e.g., for OFDM). TX MIMO processor 220 then provides N_{T} modulation symbol streams to N_{T} transmitters (TMTR) 222a through 222t. In certain embodiments, TX MIMO processor 220 applies beamforming weights to the symbols of the data streams and to the antenna from which the symbol is being transmitted.

Each transmitter 222 receives and processes a respective symbol stream to provide one or more analog signals, and further conditions (e.g., amplifies, filters, and upconverts) the analog signals to provide a modulated signal suitable for transmission over the MIMO channel. N_{T} modulated signals from transmitters 222a through 222t are then transmitted from N_{T} antennas 224a through 224t, respectively.

At receiver system 250, the transmitted modulated signals are received by N_{R} antennas 252a through 252r and the received signal from each antenna 252 is provided to a respective receiver (RCVR) 254a through 254r. Each receiver 254 conditions (e.g., filters, amplifies, and downconverts) a respective received signal, digitizes the conditioned signal to provide samples, and further processes the samples to provide a corresponding “received” symbol stream.

An RX data processor 260 then receives and processes the N_{R} received symbol streams from N_{R} receivers 254 based on a particular receiver processing technique to provide N_{T} “detected” symbol streams. The RX data processor 260 then demodulates, deinterleaves, and decodes each detected symbol stream to recover the traffic data for the data stream. The processing by RX data processor 260 is complementary to that performed by TX MIMO processor 220 and TX data processor 214 at transmitter system 210.

A processor 270 periodically determines which pre-coding matrix to use (discussed below). Processor 270 formulates a reverse link message comprising a matrix index portion and a rank value portion.

The reverse link message may comprise various types of information regarding the communication link and/or the received data stream. The reverse link message is then processed by a TX data processor 238, which also receives traffic data for a number of data streams from a data source 236, modulated by a modulator 280, conditioned by transmitters 254a through 254r, and transmitted back to transmitter system 210.

At transmitter system 210, the modulated signals from receiver system 250 are received by antennas 224, conditioned by receivers 222, demodulated by a demodulator 240, and processed by a RX data processor 242 to extract the reserve link message transmitted by the receiver system 250. Processor 230 then determines which pre-coding matrix to use for determining the beamforming weights then processes the extracted message.

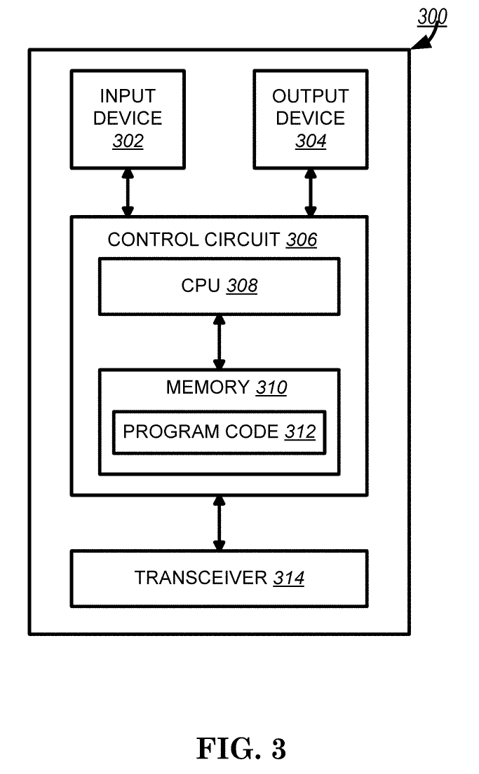

Turning to FIG. 3, this figure shows an alternative simplified functional block diagram of a communication device according to one embodiment of the invention. As shown in FIG. 3, the communication device 300 in a wireless communication system can be utilized for realizing the UEs (or ATs) 116 and 122 in FIG. 1 or the base station (or AN) 100 in FIG. 1, and the wireless communications system is preferably the LTE system. The communication device 300 may include an input device 302, an output device 304, a control circuit 306, a central processing unit (CPU) 308, a memory 310, a program code 312, and a transceiver 314. The control circuit 306 executes the program code 312 in the memory 310 through the CPU 308, thereby controlling an operation of the communications device 300. The communications device 300 can receive signals input by a user through the input device 302, such as a keyboard or keypad, and can output images and sounds through the output device 304, such as a monitor or speakers. The transceiver 314 is used to receive and transmit wireless signals, delivering received signals to the control circuit 306, and outputting signals generated by the control circuit 306 wirelessly. The communication device 300 in a wireless communication system can also be utilized for realizing the AN 100 in FIG. 1.

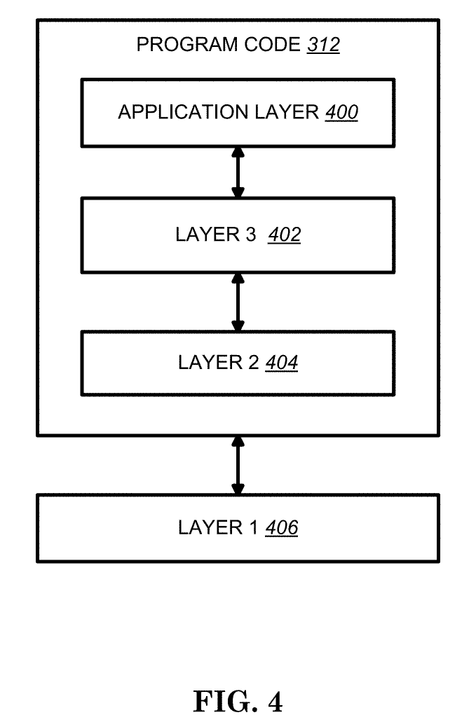

FIG. 4 is a simplified block diagram of the program code 312 shown in FIG. 3 in accordance with one embodiment of the invention. In this embodiment, the program code 312 includes an application layer 400, a Layer 3 portion 402, and a Layer 2 portion 404, and is coupled to a Layer 1 portion 406. The Layer 3 portion 402 generally performs radio resource control. The Layer 2 portion 404 generally performs link control. The Layer 1 portion 406 generally performs physical connections.

In general, the objective of the analysis and disclosure below is to study the frame structure used in New RAT (NR) for 5G, to accommodate various type of requirement (as discussed in 3GPP TR 38.913) for time and frequency resource (e.g., from ultra-low latency (˜0.5 ms) to expected longer TTI (Transmission Time Interval) for MTC (Machine Type Communication), or from high peak rate for eMBB (enhanced Mobile Broadband) to very low data rate for MTC). An important focus of the study and disclosure below is low latency aspect, while other aspect of mixing/adapting different TTIs can also be considered in the study and disclosure. In addition to diverse services and requirements, forward compatibility is an important consideration in initial NR frame structure design as not all features of NR would be included in the beginning phase/release.

3GPP standardization activities on next generation (i.e., 5G) access technology have been launched since March 2015. The next generation access technology aims to support the following three families of usage scenarios for satisfying both the urgent market needs and the more long-term requirements set forth by the ITU-R IMT-2020:
eMBB (enhanced Mobile Broadband)
mMTC (massive Machine Type Communications)
URLLC (Ultra-Reliable and Low Latency Communications).

An objective of the 5G study item on new radio access technology is to identify and develop technology components needed for new radio systems which should be able to use any spectrum band ranging at least up to 100 GHz. Supporting carrier frequencies up to 100 GHz brings a number of challenges in the area of radio propagation. As the carrier frequency increases, the path loss also increases.

In LTE, the SR (Scheduling Request) and BSR (Buffer Status Report) procedure is design for a connected mode UE to request uplink resource for data transmission. Detail of SR and BSR procedure is captured in 3GPP TS 36.321. When a UE obtains uplink resource based on SR and BSR procedure, the UE will perform multiplexing procedure to create a transport block for transmission on the uplink resource. Detail on the multiplexing procedure is also capture in 3GPP TS 36.321 as follows:

### 5.4.1 UL Grant Reception

In order to transmit on the UL-SCH the MAC entity must have a valid uplink grant (except for non-adaptive HARQ retransmissions) which it may receive dynamically on the PDCCH or in a Random Access Response or which may be configured semi-persistently or preallocated by RRC. To perform requested transmissions, the MAC layer receives HARQ information from lower layers. When the physical layer is configured for uplink spatial multiplexing, the MAC layer can receive up to two grants (one per HARQ process) for the same TTI from lower layers. If the MAC entity has a C-RNTI, a Semi-Persistent Scheduling C-RNTI, a UL Semi-Persistent Scheduling V-RNTI, or a Temporary C-RNTI, the MAC entity shall for each TTI and for each Serving Cell belonging to a TAG that has a running timeAlignmentTimer and for each grant received for this TTI and for each SPS configuration that is indicated by the PDCCH addressed to UL Semi-Persistent Scheduling V-RNTI:
if an uplink grant for this TTI and this Serving Cell has been received on the PDCCH for the MAC entity's C-RNTI or Temporary C-RNTI; or
if an uplink grant for this TTI has been received in a Random Access Response:
   if the uplink grant is for MAC entity's C-RNTI and if the previous uplink grant delivered to the HARQ entity for the same HARQ process was either an uplink grant received for the MAC entity's Semi-Persistent Scheduling C-RNTI, for the MAC entity's UL Semi-Persistent Scheduling V-RNTI, or a configured uplink grant:
      consider the NDI to have been toggled for the corresponding HARQ process regardless of the value of the NDI.
   deliver the uplink grant and the associated HARQ information to the HARQ entity for this TTI.
else, if this Serving Cell is the SpCell and if an uplink grant for this TTI has been received for the SpCell on the PDCCH of the SpCell for the MAC entity's Semi-Persistent Scheduling C-RNTI or for the MAC entity's UL Semi-Persistent Scheduling V-RNTI:
   if the NDI in the received HARQ information is 1:
      consider the NDI for the corresponding HARQ process not to have been toggled;
      deliver the uplink grant and the associated HARQ information to the HARQ entity for this TTI.
   else if the NDI in the received HARQ information is 0:
      if PDCCH contents indicate SPS release:
         if the MAC entity is configured with skipUplinkTxSPS:
         trigger an SPS confirmation;
         if an uplink grant for this TTI has been configured:
         consider the NDI bit for the corresponding HARQ process to have been toggled;
         deliver the configured uplink grant and the associated HARQ information to the HARQ entity for this TTI;
         else:
         clear the corresponding configured uplink grant (if any).
      else:
         if the MAC entity is configured with skipUplinkTxSPS:
         trigger an SPS confirmation;
         store the uplink grant and the associated HARQ information as configured uplink grant;
         initialise (if not active) or re-initialise (if already active) the configured uplink grant to start in this TTI and to recur according to rules in subclause 5.10.2;
         if UL HARQ operation is asynchronous, set the HARQ Process ID to the HARQ Process ID associated with this TTI;
         consider the NDI bit for the corresponding HARQ process to have been toggled;
         deliver the configured uplink grant and the associated HARQ information to the HARQ entity for this TTI.
else, if this Serving Cell is the SpCell and an uplink grant for this TTI has been configured or preallocated for the SpCell:
   if UL HARQ operation is asynchronous, set the HARQ Process ID to the HARQ Process ID associated with this TTI;
   consider the NDI bit for the corresponding HARQ process to have been toggled;
   deliver the configured or preallocated uplink grant, and the associated HARQ information to the HARQ entity for this TTI.
NOTE: The period of configured uplink grants is expressed in TTIs.
NOTE: If the MAC entity receives both a grant in a Random Access Response and a grant for its C-RNTI or Semi persistent scheduling C-RNTI requiring transmissions on the SpCell in the same UL subframe, the MAC entity may choose to continue with either the grant for its RA-RNTI or the grant for its C-RNTI or Semi persistent scheduling C-RNTI.
NOTE: When a configured uplink grant is indicated during a measurement gap and indicates an UL-SCH transmission during a measurement gap, the MAC entity processes the grant but does not transmit on UL-SCH. When a configured uplink grant is indicated during a Sidelink Discovery gap for reception and indicates an UL-SCH transmission during a Sidelink Discovery gap for transmission with a SL-DCH transmission, the MAC entity processes the grant but does not transmit on UL-SCH.
   For configured uplink grants, the HARQ Process ID associated with this TTI is derived from the following equation for asynchronous UL HARQ operation:
   HARQ Process ID=[floor(CURRENT_TTI/semiPersistSchedIntervalUL)] modulo numberOfConfUISPS-Processes,
   where CURRENT_TTI=[(SFN*10)+subframe number] and it refers to the subframe where the first transmission of a bundle takes place.
   For preallocated uplink grants, the HARQ Process ID associated with this TTI is derived from the following equation for asynchronous UL HARQ operation:
   HARQ Process ID=[floor(CURRENT_TTI/ul-SchedInterval)] modulo numberOfConfUL-Processes,
   where CURRENT_TTI=subframe number and it refers to the subframe where the first transmission of a bundle takes place.
   [ . . . ]

### 5.4.3 Multiplexing and Assembly

### 5.4.3.1 Logical Channel Prioritization

The Logical Channel Prioritization procedure is applied when a new transmission is performed. RRC controls the scheduling of uplink data by signalling for each logical channel: priority where an increasing priority value indicates a lower priority level, prioritisedBitRate which sets the Prioritized Bit Rate (PBR), bucketSizeDuration which sets the Bucket Size Duration (BSD). For NB-IoT, prioritisedBitRate, bucketSizeDuration and the corresponding steps of the Logical Channel Prioritisation procedure (i.e., Step 1 and Step 2 below) are not applicable. The MAC entity shall maintain a variable Bj for each logical channel j. Bj shall be initialized to zero when the related logical channel is established, and incremented by the product PBR×TTI duration for each TTI, where PBR is Prioritized Bit Rate of logical channel j. However, the value of Bj can never exceed the bucket size and if the value of Bj is larger than the bucket size of logical channel j, it shall be set to the bucket size. The bucket size of a logical channel is equal to PBR×BSD, where PBR and BSD are configured by upper layers.
The MAC entity shall perform the following Logical Channel Prioritization procedure when a new transmission is performed:
The MAC entity shall allocate resources to the logical channels in the following steps:
   Step 1: All the logical channels with Bj>0 are allocated resources in a decreasing priority order. If the PBR of a logical channel is set to “infinity”, the MAC entity shall allocate resources for all the data that is available for transmission on the logical channel before meeting the PBR of the lower priority logical channel(s);
Step 2: the MAC entity shall decrement Bj by the total size of MAC SDUs served to logical channel j in Step 1;
NOTE: The value of Bj can be negative.
   Step 3: if any resources remain, all the logical channels are served in a strict decreasing priority order (regardless of the value of Bj) until either the data for that logical channel or the UL grant is exhausted, whichever comes first. Logical channels configured with equal priority should be served equally.
The UE shall also follow the rules below during the scheduling procedures above:
   the UE should not segment an RLC SDU (or partially transmitted SDU or retransmitted RLC PDU) if the whole SDU (or partially transmitted SDU or retransmitted RLC PDU) fits into the remaining resources of the associated MAC entity;
   if the UE segments an RLC SDU from the logical channel, it shall maximize the size of the segment to fill the grant of the associated MAC entity as much as possible;
   the UE should maximise the transmission of data.
   if the MAC entity is given an UL grant size that is equal to or larger than 4 bytes while having data available for transmission, the MAC entity shall not transmit only padding BSR and/or padding (unless the UL grant size is less than 7 bytes and an AMD PDU segment needs to be transmitted);
   for transmissions on serving cells operating according to Frame Structure Type 3, the MAC entity shall only consider logical channels for which Iaa-Allowed has been configured.
      The MAC entity shall not transmit data for a logical channel corresponding to a radio bearer that is suspended (the conditions for when a radio bearer is considered suspended are defined in [8]).
      If the MAC PDU includes only the MAC CE for padding BSR or periodic BSR with zero MAC SDUs and there is no aperiodic CSI requested for this TTI [2], the MAC entity shall not generate a MAC PDU for the HARQ entity in the following cases:
in case the MAC entity is configured with skipUplinkTxDynamic and the grant indicated to the HARQ entity was addressed to a C-RNTI; or
in case the MAC entity is configured with skipUplinkTxSPS and the grant indicated to the HARQ entity is a configured uplink grant;
   For the Logical Channel Prioritization procedure, the MAC entity shall take into account the following relative priority in decreasing order:
MAC control element for C-RNTI or data from UL-CCCH;
MAC control element for SPS confirmation;
MAC control element for BSR, with exception of BSR included for padding;
MAC control element for PHR, Extended PHR, or Dual Connectivity PHR;
MAC control element for Sidelink BSR, with exception of Sidelink BSR included for padding;
data from any Logical Channel, except data from UL-CCCH;
MAC control element for BSR included for padding;
MAC control element for Sidelink BSR included for padding.
NOTE: When the MAC entity is requested to transmit multiple MAC PDUs in one TTI, steps 1 to 3 and the associated rules may be applied either to each grant independently or to the sum of the capacities of the grants. Also the order in which the grants are processed is left up to UE implementation. It is up to the UE implementation to decide in which MAC PDU a MAC control element is included when MAC entity is requested to transmit multiple MAC PDUs in one TTI. When the UE is requested to generate MAC PDU(s) in two MAC entities in one TTI, it is up to UE implementation in which order the grants are processed.

### 5.4.3.2 Multiplexing of MAC Control Elements and MAC SDUs

The MAC entity shall multiplex MAC control elements and MAC SDUs in a MAC PDU according to subclauses 5.4.3.1 and 6.1.2.

### 5.4.4 Scheduling Request

The Scheduling Request (SR) is used for requesting UL-SCH resources for new transmission. When an SR is triggered, it shall be considered as pending until it is cancelled. All pending SR(s) shall be cancelled and sr-ProhibitTimer shall be stopped when a MAC PDU is assembled and this PDU includes a BSR which contains buffer status up to (and including) the last event that triggered a BSR (see subclause 5.4.5), or, if all pending SR(s) are triggered by Sidelink BSR, when a MAC PDU is assembled and this PDU includes a Sidelink BSR which contains buffer status up to (and including) the last event that triggered a Sidelink BSR (see subclause 5.14.1.4), or, if all pending SR(s) are triggered by Sidelink BSR, when upper layers configure autonomous resource selection, or when the UL grant(s) can accommodate all pending data available for transmission.
If an SR is triggered and there is no other SR pending, the MAC entity shall set the SR_COUNTER to 0.
As long as one SR is pending, the MAC entity shall for each TTI:
if no UL-SCH resources are available for a transmission in this TTI:
   if the MAC entity has no valid PUCCH resource for SR configured in any TTI: initiate a Random Access procedure (see subclause 5.1) on the SpCell and cancel all pending SRs;
   else if the MAC entity has at least one valid PUCCH resource for SR configured for this TTI and if this TTI is not part of a measurement gap or Sidelink Discovery Gap for Transmission and if sr-ProhibitTimer is not running:
      if SR_COUNTER<dsr-TransMax:
         increment SR_COUNTER by 1;
         instruct the physical layer to signal the SR on one valid PUCCH resource for SR;
         start the sr-ProhibitTimer.
      else:
         notify RRC to release PUCCH for all serving cells;
         notify RRC to release SRS for all serving cells;
         clear any configured downlink assignments and uplink grants;
         initiate a Random Access procedure (see subclause 5.1) on the SpCell and cancel all pending SRs.
NOTE: The selection of which valid PUCCH resource for SR to signal SR on when the MAC entity has more than one valid PUCCH resource for SR in one TTI is left to UE implementation.
NOTE: SR_COUNTER is incremented for each SR bundle. sr-ProhibitTimer is started in the first TTI of an SR bundle.

### 5.4.5 Buffer Status Reporting

The Buffer Status reporting procedure is used to provide the serving eNB with information about the amount of data available for transmission in the UL buffers associated with the MAC entity. RRC controls BSR reporting by configuring the three timers periodicBSR-Timer, retxBSR-Timer and logicalChannelSR-ProhibitTimer and by, for each logical channel, optionally signalling logicalChannelGroup which allocates the logical channel to an LCG [8].
For the Buffer Status reporting procedure, the MAC entity shall consider all radio bearers which are not suspended and may consider radio bearers which are suspended.
For NB-IoT the Long BSR is not supported and all logical channels belong to one LCG.
A Buffer Status Report (BSR) shall be triggered if any of the following events occur:
UL data, for a logical channel which belongs to a LCG, becomes available for transmission in the RLC entity or in the PDCP entity (the definition of what data shall be considered as available for transmission is specified in [3] and [4] respectively) and either the data belongs to a logical channel with higher priority than the priorities of the logical channels which belong to any LCG and for which data is already available for transmission, or there is no data available for transmission for any of the logical channels which belong to a LCG, in which case the BSR is referred below to as “Regular BSR”;
UL resources are allocated and number of padding bits is equal to or larger than the size of the Buffer Status Report MAC control element plus its subheader, in which case the BSR is referred below to as “Padding BSR”;
retxBSR-Timer expires and the MAC entity has data available for transmission for any of the logical channels which belong to a LCG, in which case the BSR is referred below to as “Regular BSR”;
periodicBSR-Timer expires, in which case the BSR is referred below to as “Periodic BSR”.

### For Regular BSR:

if the BSR is triggered due to data becoming available for transmission for a logical channel for which logicalChannelSR-ProhibitTimer is configured by upper layers:
   start or restart the logicalChannelSR-ProhibitTimer;
else:
   if running, stop the logicalChannelSR-ProhibitTimer.

### For Regular and Periodic BSR:

if more than one LCG has data available for transmission in the TTI where the BSR is transmitted: report Long BSR;
else report Short BSR.

### For Padding BSR:

if the number of padding bits is equal to or larger than the size of the Short BSR plus its subheader but smaller than the size of the Long BSR plus its subheader:
   if more than one LCG has data available for transmission in the TTI where the BSR is transmitted: report Truncated BSR of the LCG with the highest priority logical channel with data available for transmission;
   else report Short BSR.
else if the number of padding bits is equal to or larger than the size of the Long BSR plus its subheader, report Long BSR.
   If the Buffer Status reporting procedure determines that at least one BSR has been triggered and not cancelled:
if the MAC entity has UL resources allocated for new transmission for this TTI:
   instruct the Multiplexing and Assembly procedure to generate the BSR MAC control element(s);
   start or restart periodicBSR-Timer except when all the generated BSRs are Truncated BSRs;
   start or restart retxBSR-Timer.
else if a Regular BSR has been triggered and logicalChannelSR-ProhibitTimer is not running:
   if an uplink grant is not configured or the Regular BSR was not triggered due to data becoming available for transmission for a logical channel for which logical channel SR masking (logicalChannelSR-Mask) is setup by upper layers:
      a Scheduling Request shall be triggered.
         A MAC PDU shall contain at most one MAC BSR control element, even when multiple events trigger a BSR by the time a BSR can be transmitted in which case the Regular BSR and the Periodic BSR shall have precedence over the padding BSR.
         The MAC entity shall restart retxBSR-Timer upon indication of a grant for transmission of new data on any UL-SCH.
         All triggered BSRs shall be cancelled in case the UL grant(s) in this TTI can accommodate all pending data available for transmission but is not sufficient to additionally accommodate the BSR MAC control element plus its subheader. All triggered BSRs shall be cancelled when a BSR is included in a MAC PDU for transmission.
         The MAC entity shall transmit at most one Regular/Periodic BSR in a TTI. If the MAC entity is requested to transmit multiple MAC PDUs in a TTI, it may include a padding BSR in any of the MAC PDUs which do not contain a Regular/Periodic BSR.
         All BSRs transmitted in a TTI always reflect the buffer status after all MAC PDUs have been built for this TTI. Each LCG shall report at the most one buffer status value per TTI and this value shall be reported in all BSRs reporting buffer status for this LCG.
NOTE: A Padding BSR is not allowed to cancel a triggered Regular/Periodic BSR, except for NB-IoT. A Padding BSR is triggered for a specific MAC PDU only and the trigger is cancelled when this MAC PDU has been built.
   [ . . . ]

### 6.1.3 MAC Control Elements

### 6.1.3.1 Buffer Status Report MAC Control Elements

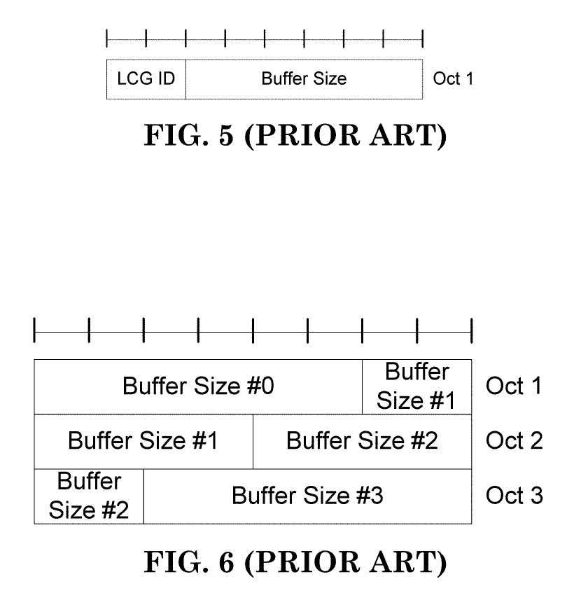

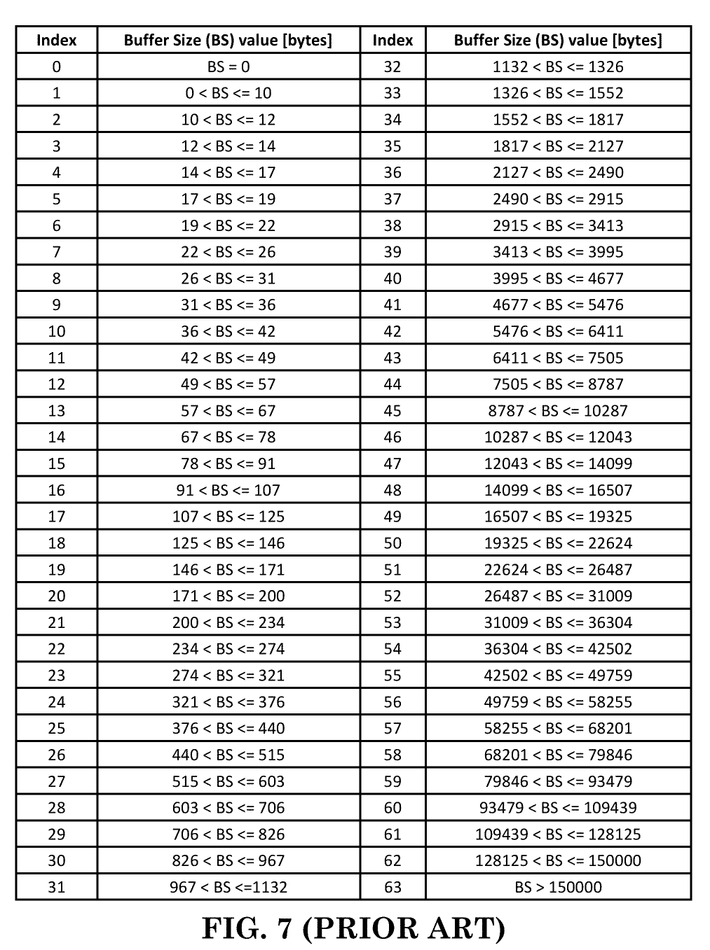

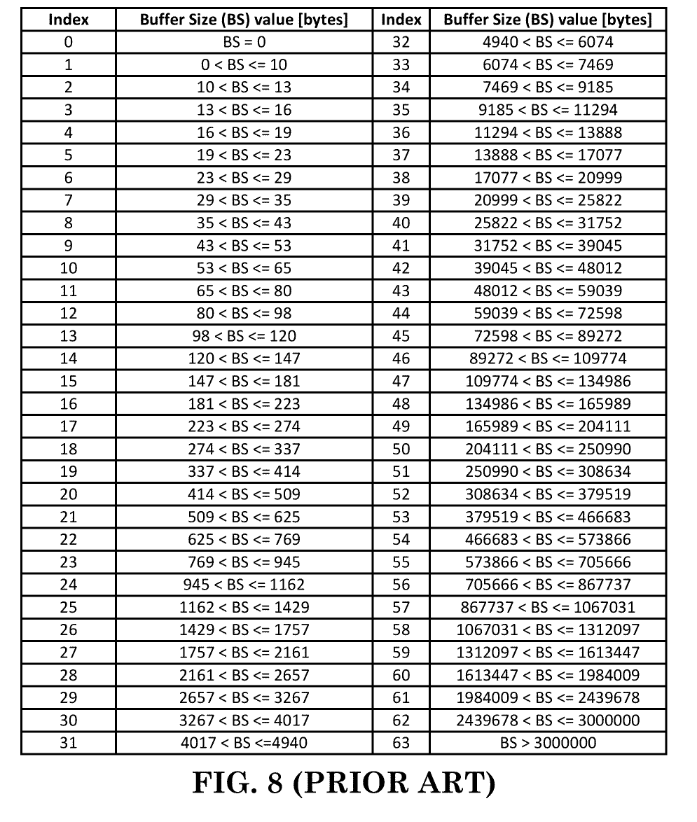

Buffer Status Report (BSR) MAC control elements consist of either:
Short BSR and Truncated BSR format: one LCG ID field and one corresponding Buffer Size field (figure 6.1.3.1-1); or
Long BSR format: four Buffer Size fields, corresponding to LCG IDs #0 through #3 (figure 6.1.3.1-2).
   The BSR formats are identified by MAC PDU subheaders with LCIDs as specified in table 6.2.1-2.
   The fields LCG ID and Buffer Size are defined as follow:
LCG ID: The Logical Channel Group ID field identifies the group of logical channel(s) which buffer status is being reported. The length of the field is 2 bits;
Buffer Size: The Buffer Size field identifies the total amount of data available across all logical channels of a logical channel group after all MAC PDUs for the TTI have been built. The amount of data is indicated in number of bytes. It shall include all data that is available for transmission in the RLC layer and in the PDCP layer; the definition of what data shall be considered as available for transmission is specified in [3] and [4] respectively. The size of the RLC and MAC headers are not considered in the buffer size computation. The length of this field is 6 bits. If extendedBSR-Sizes is not configured, the values taken by the Buffer Size field are shown in Table 6.1.3.1-1. If extendedBSR-Sizes is configured, the values taken by the Buffer Size field are shown in Table 6.1.3.1-2.
[Figure 6.1.3.1-1 of 3GPP TS 36.321 V14.0.0, entitled “Short BSR and Truncated BSR MAC control element”, is reproduced as FIG. 5]
[Figure 6.1.3.1-2 of 3GPP TS 36.321 V14.0.0, entitled “Long BSR MAC control element”, is reproduced as FIG. 6]
[Table 6.1.3.1-1 of 3GPP TS 36.321 V14.0.0, entitled “Buffer size levels for BSR”, is reproduced as FIG. 7]
[Table 6.1.3.1-2 of 3GPP TS 36.321 V14.0.0, entitled “Extended Buffer size levels for BSR”, is reproduced as FIG. 8]

In legacy LTE, a UE can request resource for uplink transmission through SR and BSR mechanism. In general, the network will dynamically allocate resource to a UE based on a BSR transmitted from the UE. In the current NR discussion, there may also be grant free resource (e.g., configured grant type 1, configured grant type 2) used for URLLC transmission. Whether the grant free resource could also be used on eMBB or other service is for further study. The grant free resource could be contention based or dedicatedly scheduled for a UE. The grant free resource will be persistently or semi-persistently allocated to a UE.

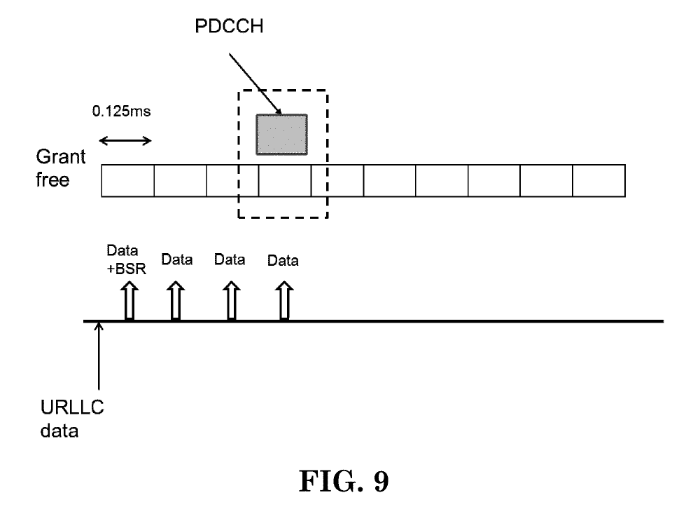

Moreover, although a UE has grant free resource, it is still possible for network to schedule dynamic resource to the UE. There are some possible conditions for such scheduling. FIG. 9 illustrates an example, according to one embodiment, where the network may schedule further resource if the BSR transmitted from UE indicates more resource demand. The network can schedule extra resource through control channel, e.g., PDCCH (Physical Downlink Control Channel). Since grant free resource may be allocated in every TTI for reducing latency, the extra scheduled resource may collide with the grant free resource(s).

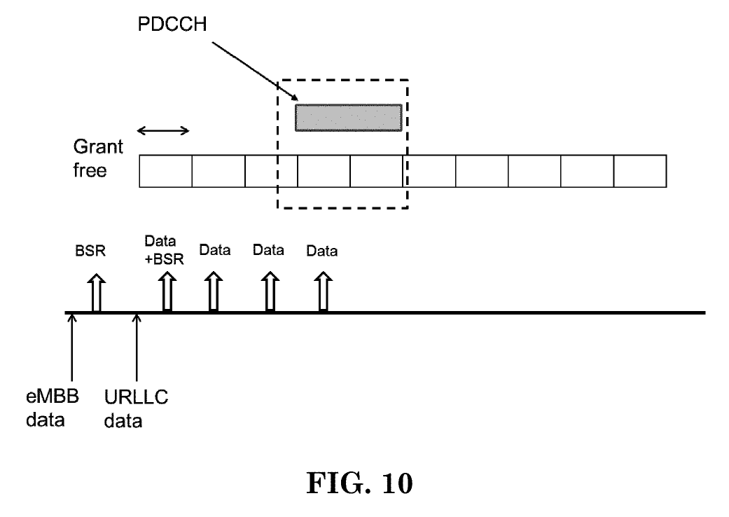

FIG. 10 illustrates another possible condition according to one exemplary embodiment. In FIG. 10, since the network receives more than one BSR from a UE for different events (e.g., URLLC data arrival and eMBB data arrival), the network could decide to schedule extra resources to the UE for URLLC (Ultra-Reliable and Low Latency Communication) data or eMBB data or both. However, the UE may not be capable to use both (configured) grant free resource and dynamically scheduled resource at the same time (e.g., same TTI) due to capability limitation. In LTE, a similar condition for collision between SPS (Semi-Persistent Scheduling) resource and dynamic scheduling resource at the same time (e.g. same TTI) could occur. The solution in LTE is that dynamic scheduling resource will always override SPS resource. However, it may not be appropriate to adopt the same solution in NR due to some considerations.

One possible consideration is about service latency requirement. In FIG. 10, if the dynamically scheduled resource is for eMBB data and the dynamically scheduled resource cannot meet latency requirement of URLLC data, replacing (configured) grant free resource with dynamically scheduled resource will cause a problem for URLLC transmission. A further discussion is provided below regarding how a UE handle such multiple uplink resources collision case if the UE cannot use all of the multiple uplink resources.

Assuming the UE has more than one uplink resource collided in time domain, the MAC layer of the UE can choose to take one of the following actions.
1. The UE could create multiple corresponding TBs (Transport Blocks) based on all uplink resources, but prioritize transmissions of one or more TBs based on UE capability. The rest of the transmissions will be delayed and/or be considered as already performed.
2. The UE could use one or more uplink resources based on the UE's capability and create corresponding TBs. The rest of uplink resources will be discarded, ignored, or overridden.

Regarding how the UE determines prioritization between different uplink resources and/or different transmissions for above actions, the following methods are proposed:
A. Prioritization based on one or multiple criteria of uplink resource (e.g., shorter TTI, larger TB size, cell (e.g. PCell/Scell), or frequency range, etc.)
B. Prioritize dynamically scheduled resource if the control signal for scheduling the dynamically scheduled resource includes override indication (explicit or implicit).
C. Prioritize based on data available for transmission in the UE.
D. Hybrid of above solutions

Combination Solution 1A—

Regarding combination solution 1A, when there is enough data available for transmission, the UE will create multiple TBs for the multiple uplink resources based on a LCP (Logical Channel Prioritization) procedure. After the UE creates the TBs, the UE will prioritize transmission(s) of the TB(s) based on the criteria of the multiple uplink resources.

In one embodiment, the criteria could include a TTI length of the uplink resources. For example, transmission of uplink resources with the shortest TTI length could be performed first. As another example, different TTI lengths may be grouped together based on different ranges. And uplink resources for different groups will have different priorities. In one embodiment, transmission of uplink resources within a group having a range of shortest TTI lengths will be performed first. The uplink resources within same group may also be prioritized based on other criteria. In one embodiment, the TTI length could be a time interval from reception scheduling control signal for the uplink resource till end of corresponding data transmission associated with the uplink resource. In another embodiment, the TTI length could be a time interval from start of data transmission associated with the uplink resource till end of the data transmission. In another embodiment, the TTI length could be a time unit of the uplink resource.

In one embodiment, the criteria could include a TB size of the uplink resource. For example, a specific TB size or a range of TB size could be prioritized. As another example, uplink resource with larger TB size could be prioritized.

In one embodiment, the criteria could include numerology (e.g., subcarrier spacing, bandwidth part) of uplink resource. For example, the network could configure and/or decide a relation between priorities and numerologies. As another example, numerology with larger subcarrier spacing could be prioritized. As a further example, a default or reference numerology could be prioritized. As another example, transmission of the uplink resource on a bandwidth part with larger numerology could be prioritized. As another example, network could configure the priority of different numerologies or different bandwidth parts in bandwidth part configuration(s).

In one embodiment, the criteria could include serving cell of uplink resource. For example, uplink resource from PCell could have higher priority than SCell since SCell is for assistance.

In one embodiment, the criteria could include the frequency of uplink resource. For example, uplink resource on low frequency could have lower path loss and effected noise, and the UE could prioritize transmission(s) of TB(s) on uplink resource with lower frequency. As another example, the UE could prioritize transmission(s) of TB(s) on uplink resource with higher frequency due to the utilization of higher frequency resource in NR.

Combination Solution 2A—

Regarding combination solution 2A, the UE could decide which uplink resource will be used, instead of directly discarding grant free resource, based on the criteria of the multiple uplink resources. In one embodiment, the criteria could include TTI length of uplink resource. For example, uplink resource with shorter TTI length could be prioritized. As another example, different TTI lengths could be grouped together with different ranges (e.g., one range for 0˜0.5 ms, another range for <0.5 ms). Uplink resources for different groups could have different priority. For example, uplink resources within a group having shortest TTI length range could be prioritized.

Uplink resources within a same group could also be prioritized based on other criteria. The TTI length could be a time interval from receiving the scheduling (e.g., receive a downlink control information or consider the uplink resource is configured) to finish of corresponding data transmission, a time interval of the corresponding data transmission, or a timer unit of the uplink resource.

In one embodiment, the criteria could include TB size of uplink resource. As an example, a specific TB size could be prioritized. As another example, uplink resource with larger TB size could be prioritized.

In one embodiment, the criteria could include numerology (e.g., subcarrier spacing, bandwidth part) of uplink resource. For example, the network could configure or decide relation between priorities and numerologies. As another example, numerology with larger subcarrier spacing could be prioritized. As a further example, the default or reference numerology could be prioritized. As another example, the uplink resource on a bandwidth part with larger numerology could be prioritized. As another example, network could configure the priority of different numerologies or bandwidth parts in bandwidth part configuration(s).

In one embodiment, the criteria could include serving cell of uplink resource. For example, uplink resource from PCell may have higher priority than SCell since SCell is for assistance.

In one embodiment, the criteria could include the frequency of uplink resource. For example, uplink resource on low frequency could have lower path loss and effected noise, and the UE could prioritize uplink resource on lower frequency. As another example, the UE could prioritize uplink resource on higher frequency due to the utilization of higher frequency resource in NR.

In one embodiment, the criteria could include related BWP (bandwidth part) of the uplink resource. For example, the UE could prioritize resource(s) on default BWP and/or initial BWP over other uplink resource(s) not on default and/or initial BWP. For another example, the UE could prioritize the uplink resource on a BWP configured with grant free resource. For another example, network could configure priority of uplink resource on different BWPs in BWP configuration(s).

Combination Solution 1B—

Regarding combination solution 1B, when there is enough data available for transmission, the UE could create multiple TBs for the available uplink resource based on the LCP procedure. Then the UE could receive the control signal for scheduling (e.g., PDCCH signal, downlink control information). If the control signal includes an (explicit or implicit) override indication, the UE transmits corresponding TB(s) on dynamically scheduled resource indicated by the control signal. In one embodiment, if the control signal does not include override indication, the UE could use method 1A or 1C, or a possible combination solution of 1A and 1C to prioritize transmission(s) of the TB(s). In one embodiment, the indication could be an explicit field of control signal for scheduling. The indication could also be a special value within existed field (e.g., Resource block assignment, New data indicator, Modulation and coding scheme, HARQ (Hybrid Automatic Repeat Request) process number, Redundancy version, acknowledge timing, data transmission timing/offset, control signal transmission timing, UE beam/network beam indication, numerology, TTI length, . . . ).

In another embodiment, the indication could tell the UE to override an uplink resource which is already allocated to the UE based on comparison of a specific value. For example, if the UE receives a new uplink resource when the UE already has one, the UE could use the new uplink resource if the new uplink resource and the resource allocated previously are exclusive in specific aspect(s)(e.g., frequency resource overlapped, same cell, same RNTI, same TTI length, same numerology, same UE beam, same network beam, etc.).

Combination Solution 2B—

Regarding combination solution 2B, if a UE receives a control signal for scheduling (e.g., PDCCH) that includes an override indication (explicit or implicit), the UE could use the dynamically scheduled resource indicated by the control signal. If a UE receives a control signal for scheduling (e.g., PDCCH) that does not include override indication, the UE could use method or combination solution 2A or 2C to prioritize uplink resource based on the criteria of uplink resource, the data available for transmission, or decide by UE implementation. The rest of the uplink resource could be discarded or ignored.

In one embodiment, the indication could be an explicit field of control signal for scheduling. The indication could also be a special value within existed field (e.g., Resource block assignment, New data indicator, Modulation and coding scheme, HARQ process number, Redundancy version, acknowledge timing, data transmission timing/offset, control signal transmission timing, UE beam/network beam indication, numerology, TTI length, etc.).

In one embodiment, the indication could indicate the UE to override uplink resource which is already allocated to the UE based on comparison of a specific value. For example, if the UE receives a new uplink resource when the UE already has one, the UE could use the new uplink resource if the new uplink resource and the resource allocated previously are exclusive in specific aspect(s) (e.g., frequency resource overlapped, same cell, same RNTI, same TTI length, same numerology, same UE beam, same network beam, . . . ).

Combination Solution 1C—

Regarding combination solution 1C, when there is enough data available for transmission, the UE could create multiple TBs for the available uplink resource based on a LCP procedure. After the UE creates the TBs, the UE could prioritize transmission of those TBs based on what data being included. More specifically, the UE could prioritize depending on data included in the TBs and configuration of the logical channels associated with the data.

In one embodiment, the configuration could be the priority of logical channel. The priority of logical channel may or may not be used in the LCP procedure for multiplexing TBs. For example, the UE could first transmit a TB that includes data from higher priority logical channel. And if the UE is allowed to perform transmission(s) of other TBs in the physical layer (e.g., multiple frequencies, carriers, or bands transmission capability, multiple transmissions only partially overlapped in time domain due to different TTI lengths or different start offsets), the UE could select to perform transmission of another TB including data with higher priority than data in the rest of the TBs.

Combination Solution 2C—

Regarding combination solution 2C, a UE could prioritize uplink resource(s) based on data available for transmission in logical channel. More specifically, the UE could prioritize an uplink resource depending on the configuration of the logical channels with data available for transmission. In current discussion, logical channels could be configured with different limitations (e.g., TTI, numerology, cell, etc.) on selecting usable uplink resource. The main considerations is based on diversity of service requirements. For example, a logical channel for URLLC data can be limited to shorter TTI or larger subcarrier spacing (SCS) for achieving low latency requirement, while another logical channel for eMBB data could have different limitations. In such case, a received uplink grant may be able to serve only logical channel for eMBB data based on limitation of TTI and/or SCS, even if the logical channel for URLLC data has higher priority and data available for transmission. For another example, two logical channels for different eMBB data (e.g., web browsing based on TCP protocol, VoIP/Video streaming, etc.) could have different limitations.

In one embodiment, the configuration could be a priority of logical channel. In one embodiment, the priority of logical channel could be used in a LCP procedure for multiplexing TBs. Alternatively, the priority of logical channel may not be used in a LCP procedure for multiplexing TBs. For example, the UE could use an uplink resource which can serve higher priority logical channel with data available compared with another uplink resource. After such filtering, if remaining uplink resources are more than the UE could use, the UE may need to further down-select based on combination solution 2A or based on other rules (e.g., receiving order, random selection, etc.). The rest of the uplink resources could be discarded, ignored, or overridden. In another embodiment, the configuration could be delay budget information of logical channel or QoS (Quality of Service) information (e.g., QCI, 5QI (5G QoS Indicator)) of logical channel.

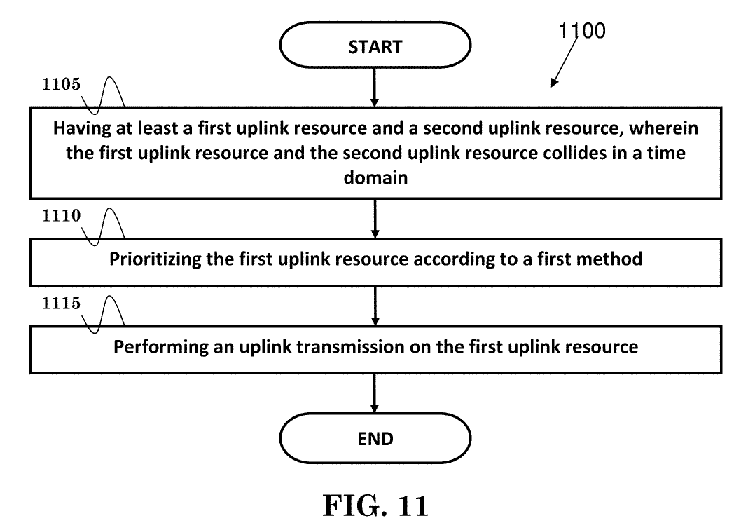

FIG. 11 is a flow chart 1100 according to one exemplary embodiment from the perspective of a UE. In step 1105, the UE has at least a first uplink resource and a second uplink resource, wherein the first uplink resource and the second uplink resource collides in a time domain. In one embodiment, the first uplink resource collides with the second uplink resource in time domain could mean that the corresponding data transmission opportunities of the first uplink resource and the second uplink resource will be overlapped within a certain period. In an alternative embodiment, the first uplink resource collides with the second uplink resource in time domain could mean that the corresponding data transmission opportunities of the first uplink resource and the second uplink resource will be started at the same timing.

In step 1110, the UE prioritizes the first uplink resource according to a first method. In one embodiment, the first method could be based on one or multiple criteria of the first uplink resource and the second uplink resource. For example, the first method could be based on an information in a control signal for scheduling the first uplink resource or the second uplink resource. As another example, the first method could be based on data available for transmission in the UE.

In one embodiment, the UE could prioritize the first uplink resource according to the first method and a second method. The second method could be based on a criterion of uplink resource. The second method could be based on data available for transmission in the UE.

In one embodiment, the criterion could include a TTI length, a numerology, a bandwidth part information, a cell information, and/or a frequency of uplink resource (e.g., on high/low frequency).

In one embodiment, the first uplink resource is a grant-free resource, a SPS (Semi-Persistent Scheduling) resource, or a dynamically scheduled resource. Similarly, the second uplink resource could also be a grant-free resource, a SPS resource, or a dynamically scheduled resource. In one embodiment, the grant-free resource could be configured grant type1. In one embodiment, the SPS resource could be configured grant type2.

In step 1115, the UE performs an uplink transmission on the first uplink resource. In one embodiment, the UE performs the uplink transmission based on prioritization result. In one embodiment, the UE could prioritize the first uplink resource if the first uplink resource can serve a higher priority logical channel with data than the second uplink grant can. Furthermore, the UE does not perform another uplink transmission based on the second uplink resource.

Referring back to FIGS. 3 and 4, in one exemplary embodiment of a UE, the device 300 includes a program code 312 stored in the memory 310. The CPU 308 could execute program code 312 (i) to have at least a first uplink resource and a second uplink resource, wherein the first uplink resource and the second uplink resource collides in time domain, (ii) to prioritize the first uplink resource according to a first method, and (iii) to perform an uplink transmission on the first uplink resource. Furthermore, the CPU 308 can execute the program code 312 to perform all of the above-described actions and steps or others described herein.

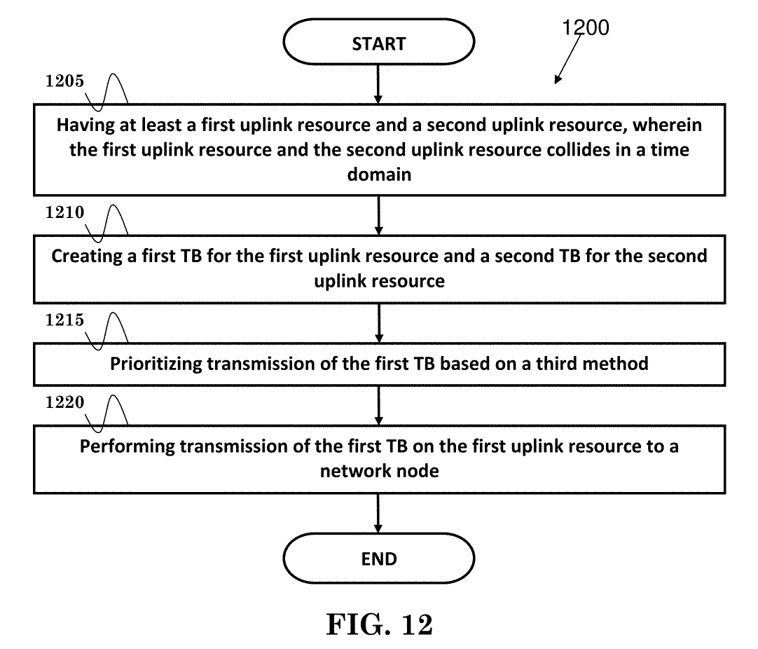

FIG. 12 is a flow chart 1200 according to one exemplary embodiment from the perspective of a UE. In step 1205, the UE has at least a first uplink resource and a second uplink resource, wherein the first uplink resource and the second uplink resource collides in a time domain. In step 1210, the UE creates a first transport block (TB) for the first uplink resource and a second TB for the second uplink resource. In step 1215, the UE prioritizes transmission of the first TB based on a third method. In step 1220, the UE performs the transmission of the first TB on the first uplink resource to a network node.

In one embodiment, the UE does not perform another uplink transmission based on the second uplink resource. In one embodiment, the third method could be based on a criterion of the first uplink resource and the second uplink resource. For example, the third method could be based on an indication of a control signal. Alternatively, the third method could be based on data included in the first TB and data included in the second TB. The third method could also be based on a configuration (e.g., priority or QoS information) of a logical channel with data being included into TB.

In one embodiment, the UE could perform transmission of the second TB after the transmission of the first TB is finished, if TTI length of the second uplink resource is longer than TTI length of the first uplink resource. The TTI length of the second uplink resource could be longer than a threshold plus the TTI of the first uplink resource.

In one embodiment, the UE could transmit using a grant-free resource indication (e.g., scheduling request, special preamble, uplink control signal, etc.) if the first uplink resource and/or the second uplink resource is grant-free resource.

Referring back to FIGS. 3 and 4, in one exemplary embodiment of a UE, the device 300 includes a program code 312 stored in the memory 310. The CPU 308 could execute program code 312 (i) to have at least a first uplink resource and a second uplink resource, wherein the first uplink resource and the second uplink resource collides in a time domain, (ii) to create a first TB for the first uplink resource and a second TB for the second uplink resource, (iii) to prioritize transmission of the first TB based on a third method, and (iv) to perform transmission of the first TB on the first uplink resource to a network node. Furthermore, the CPU 308 can execute the program code 312 to perform all of the above-described actions and steps or others described herein.

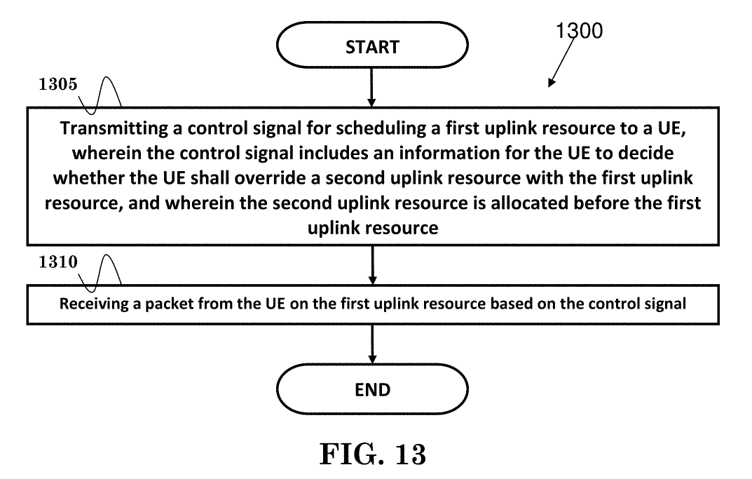

FIG. 13 is a flow chart 1300 according to one exemplary embodiment from the perspective of a network node. In step 1305, the network node transmits a control signal for scheduling a first uplink resource to a UE, wherein the control signal includes an information for the UE to decide whether the UE shall override a second uplink resource with the first uplink resource, and wherein the second uplink resource is allocated before the first uplink resource. In step 1310, the network node receives a packet from the UE on the first uplink resource based on the control signal.

In one embodiment, the control signal for the first uplink resource could be a PDCCH signal. In one embodiment, the uplink resource and the second uplink resource collide in a time domain

In one embodiment, the override of the second uplink resource could mean that the UE will discard or ignore the second uplink resource(s). The second uplink resource could be a grant-free resource, a SPS resource, or a dynamically scheduled resource (e.g., a PDCCH).

Referring back to FIGS. 3 and 4, in one exemplary embodiment of a network node, the device 300 includes a program code 312 stored in the memory 310. The CPU 308 could execute program code 312 (i) to transmit a control signal for scheduling a first uplink resource to a UE, wherein the control signal includes an information for the UE to decide whether the UE shall override a second uplink resource with the first uplink resource, and wherein the second uplink resource is allocated before the first uplink resource, and (ii) to receive a packet from the UE on the first uplink resource based on the control signal. Furthermore, the CPU 308 can execute the program code 312 to perform all of the above-described actions and steps or others described herein.

In the context of the embodiments illustrated in FIGS. 11, 12, and 13, and discussed above, in one embodiment, the criteria could be related to a TTI length, a TB size, or a numerology. The criteria could also be related to cell index or cell configuration (e.g., PCell or SCell). Furthermore, the criteria could be related to frequency of uplink resource (e.g., high or low frequency).

In one embodiment, the information could indicate whether uplink resource should be overridden. The information could be an explicit indication or a special value for existed field.

In one embodiment, the data is available for transmission in the UE could mean that the UE has to transmit the data.

In one embodiment, the first uplink resource could be a grant-free resource, a SPS resource, or a dynamically scheduled resource (e.g., a PDCCH). The first or second uplink resource could be pre-allocated. Furthermore, the first or second uplink resource could be allocated semi-persistently. In addition, the first or second uplink resource could requested by the UE through SR and/or BSR procedure. The first or second uplink resource could be allocated dynamically. The first or second uplink resource could also be allocated by the network node. In one embodiment, the first uplink resource and the second uplink resource can be used for data transmission. In one embodiment, the first uplink resource and the second uplink resource could be (NR-)PUSCH resource. In one embodiment, the first uplink resource and the second uplink resource could be used for data transmissions on the same cell. In one embodiment, the first uplink resource and the second uplink resource could be used for data transmissions on the same bandwidth part.

In one embodiment, the network node could be a central unit (CU), a distributed unit (DU), a transmission/reception point (TRP), a base station (BS), a 5G node, or a gNB.

In one embodiment, the UE may not capable of performing transmission of the first uplink resource and transmission of the second uplink resource at same time. In addition, the UE could be allowed to perform transmission of multiple TBs in physical layer perspective (e.g., multiple frequency, carrier, or band transmission capability, multiple transmissions only partially overlapped in Time domain due to different TTI lengths or different start offsets).

Various aspects of the disclosure have been described above. It should be apparent that the teachings herein may be embodied in a wide variety of forms and that any specific structure, function, or both being disclosed herein is merely representative. Based on the teachings herein one skilled in the art should appreciate that an aspect disclosed herein may be implemented independently of any other aspects and that two or more of these aspects may be combined in various ways. For example, an apparatus may be implemented or a method may be practiced using any number of the aspects set forth herein. In addition, such an apparatus may be implemented or such a method may be practiced using other structure, functionality, or structure and functionality in addition to or other than one or more of the aspects set forth herein. As an example of some of the above concepts, in some aspects concurrent channels may be established based on pulse repetition frequencies. In some aspects concurrent channels may be established based on pulse position or offsets. In some aspects concurrent channels may be established based on time hopping sequences. In some aspects concurrent channels may be established based on pulse repetition frequencies, pulse positions or offsets, and time hopping sequences.

Those of skill in the art would understand that information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

Those of skill would further appreciate that the various illustrative logical blocks, modules, processors, means, circuits, and algorithm steps described in connection with the aspects disclosed herein may be implemented as electronic hardware (e.g., a digital implementation, an analog implementation, or a combination of the two, which may be designed using source coding or some other technique), various forms of program or design code incorporating instructions (which may be referred to herein, for convenience, as “software” or a “software module”), or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present disclosure.

In addition, the various illustrative logical blocks, modules, and circuits described in connection with the aspects disclosed herein may be implemented within or performed by an integrated circuit (“IC”), an access terminal, or an access point. The IC may comprise a general purpose processor, a digital signal processor (DSP), an application specific integrated circuit (ASIC), a field programmable gate array (FPGA) or other programmable logic device, discrete gate or transistor logic, discrete hardware components, electrical components, optical components, mechanical components, or any combination thereof designed to perform the functions described herein, and may execute codes or instructions that reside within the IC, outside of the IC, or both. A general purpose processor may be a microprocessor, but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

It is understood that any specific order or hierarchy of steps in any disclosed process is an example of a sample approach. Based upon design preferences, it is understood that the specific order or hierarchy of steps in the processes may be rearranged while remaining within the scope of the present disclosure. The accompanying method claims present elements of the various steps in a sample order, and are not meant to be limited to the specific order or hierarchy presented.

The steps of a method or algorithm described in connection with the aspects disclosed herein may be embodied directly in hardware, in a software module executed by a processor, or in a combination of the two. A software module (e.g., including executable instructions and related data) and other data may reside in a data memory such as RAM memory, flash memory, ROM memory, EPROM memory, EEPROM memory, registers, a hard disk, a removable disk, a CD-ROM, or any other form of computer-readable storage medium known in the art. A sample storage medium may be coupled to a machine such as, for example, a computer/processor (which may be referred to herein, for convenience, as a “processor”) such the processor can read information (e.g., code) from and write information to the storage medium. A sample storage medium may be integral to the processor. The processor and the storage medium may reside in an ASIC. The ASIC may reside in user equipment. In the alternative, the processor and the storage medium may reside as discrete components in user equipment. Moreover, in some aspects any suitable computer-program product may comprise a computer-readable medium comprising codes relating to one or more of the aspects of the disclosure. In some aspects a computer program product may comprise packaging materials.

While the invention has been described in connection with various aspects, it will be understood that the invention is capable of further modifications. This application is intended to cover any variations, uses or adaptation of the invention following, in general, the principles of the invention, and including such departures from the present disclosure as come within the known and customary practice within the art to which the invention pertains.

1. A method of a UE (User Equipment), comprising:
having at least a first uplink resource and a second uplink resource, wherein the first uplink resource and the second uplink resource collides in a time domain;
prioritizing the first uplink resource according to a first method; and
performing an uplink transmission on the first uplink resource.

2. The method of claim 1, wherein the first method is based on one or multiple criteria of the first uplink resource and the second uplink resource.

3. The method of claim 1, wherein the first method is based on an information in a control signal for scheduling the first uplink resource or the second uplink resource.

4. The method of claim 1, wherein the first method is based on data available for transmission in the UE.

5. The method of claim 1, wherein the first uplink resource collides with the second uplink resource in time domain means that the corresponding data transmission opportunities of the first uplink resource and the second uplink resource will be overlapped within a certain period.

6. The method of claim 1, wherein the first uplink resource collides with the second uplink resource in time domain means that the corresponding data transmission opportunities of the first uplink resource and the second uplink resource will be started at the same timing.

7. The method of claim 1, further comprising:
the UE prioritizes the first uplink resource if the first uplink resource can serve a higher priority logical channel with data than the second uplink resource can.

8. The method of claim 2, wherein the criteria includes a TTI (Transmission Time Interval) length, a numerology, a cell information, a bandwidth part information, or a frequency of uplink resource.

9. The method of claim 1, wherein the first uplink resource is a grant-free resource, a SPS (Semi-Persistent Scheduling) resource, or a dynamically scheduled resource.

10. The method of claim 1, wherein the second uplink resource is a grant-free resource, a SPS (Semi-Persistent Scheduling) resource, or a dynamically scheduled resource.

11. The method of claim 1, further comprising:
the UE does not perform another uplink transmission based on the second uplink resource.

12. A UE (User Equipment), comprising:
a control circuit;
a processor installed in the control circuit; and
a memory installed in the control circuit and operatively coupled to the processor;
wherein the processor is configured to execute a program code stored in the memory to:
have at least a first uplink resource and a second uplink resource, wherein the first uplink resource and the second uplink resource collides in a time domain;
prioritize the first uplink resource according to a first method; and
perform an uplink transmission on the first uplink resource.

13. The UE of claim 12, wherein the first method is based on one or multiple criteria of the first uplink resource and the second uplink resource.

14. The UE of claim 12, wherein the first method is based on data available for transmission in the UE.

15. The UE of claim 12, wherein the first uplink resource collides with the second uplink resource in time domain means that the corresponding data transmission opportunities of the first uplink resource and the second uplink resource will be overlapped within a certain period.

16. The UE of claim 12, wherein the first uplink resource collides with the second uplink resource in time domain means that the corresponding data transmission opportunities of the first uplink resource and the second uplink resource will be started at the same timing.

17. The UE of claim 12, wherein the processor is further configured to execute the program code stored in the memory to:
prioritize the first uplink resource if the first uplink resource can serve a higher priority logical channel with data than the second uplink resource can.

18. The UE of claim 13, wherein the criteria includes a TTI (Transmission Time Interval) length, a numerology, a cell information, a bandwidth part information, or a frequency of uplink resource.

19. The UE of claim 12, wherein the first uplink resource is a grant-free resource, a SPS (Semi-Persistent Scheduling) resource, or a dynamically scheduled resource.

20. The UE of claim 12, wherein the second uplink resource is a grant-free resource, a SPS (Semi-Persistent Scheduling) resource, or a dynamically scheduled resource.
